(19) United States
(12) Patent Application Publication
(10) Pub. No.: US 2022/0405817 A1
(43) Pub. Date: Dec. 22, 2022

(54) VIRTUALIZED WHOLESALING

(71) Applicant: Pod Foods Co., San Francisco, CA (US)

(72) Inventors: Larissa Russell, Los Angeles, CA (US); Fiona Lee, Chicago, IL (US)

(21) Appl. No.: 17/349,378

(22) Filed: Jun. 16, 2021

(51) Int. Cl. G06Q 30/06; G06Q 10/08; G06Q 30/02

(52) U.S. Cl. CPC G06Q 30/0605; G06Q 10/087; G06Q 30/0641; G06Q 30/0202; G06Q 30/0201

(57) ABSTRACT

In virtualized wholesaling, orders may be filled without pre-stocked product, and rapidly enough for the product to be on the retailer's shelf in a just-in-time (JIT) fashion that benefits the manufacturer/vendor. The virtualized wholesaler can promote sales without requiring substantial pre-stocking of products that may not have a large-volume presence, and the retailer can exploit long-tail economics to increase its variety of product offerings and reach specific, often niche products and consumers with reduced risk of dead shelf space.

### BACKGROUND

Legacy wholesaling presents a bottleneck for manufacturers, vendors, and retailers alike. Where a legacy wholesaler has inherent resource limitations, ranging from physical space in warehouses to negotiable relationships, a wholesaler is obliged to maximize return by selecting what it perceives to be the best selling, high sales volume items. Consequently, a legacy wholesaler who expends resources to place a newly established or niche product may suffer an opportunity cost from not selling a higher volume, non-niche product. Similar considerations drive retailers toward high-volume products; they may be unaware of certain niche products unless exposed to them by a consumer customer or the manufacturer/vendor themselves, and, even if aware, absent a ready supply at the wholesaler, the retailer has little incentive to devote valuable shelf space to an unproven or specialized product.

Correspondingly, manufacturers and vendors of niche items are constrained in product distribution and placement. For a manufacturer or vendor of a niche product, wholesaling may be limited to niche wholesalers or even shut out of wholesaling entirely. As a result, all parties (manufacturers, vendors, wholesalers, and retailers) may suffer from limited opportunities to build relationships with one another. Accordingly, niche products can be denied meaningful access to a significant portion of the general market.

On the other hand, with the advent of e-commerce, online retailers do not suffer from such constraints. Because online retailers do not have physical shelf space, they can surface through their product search engines a relatively unconstrained number and variety of products. Even a bricks-and-mortar bookstore, for example, that might formerly have placed perhaps the thousand best-selling books, can expand its offerings through online sales so as also to offer the next million best-selling books. In other words, because it has virtualized shelf space, the bookstore can realize sales on both best-sellers and non-best sellers, turning what at best might be a loss-leading proposition into profitable sales; even though number of sales of non-best-sellers may be few, the retailer can “make it up on volume,” a phenomenon known as “long-tail economics.”

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture for implementing a platform that matches retailers with vendors.

FIG. 2 illustrates various components of a server that implements virtualized wholesaling.

FIG. 3 is a flow diagram of an example process performed at least in part by the server for implementing product and/or brand recommendations to a retailer.

FIG. 4 is a flow diagram of an example process performed at least in part by the server for implementing virtualized wholesaling of a vendor's product offerings.

FIG. 5 is a flow diagram of an example process performed at least in part by the server for implementing predictive analytics and machine learning.

### DETAILED DESCRIPTION

The situation described above presents itself as an opportunity for newly established or niche manufacturers and vendors to enter a market previously closed to them, or at least one in which it would be difficult to gain any traction. One way to do this would be for the manufacturer or vendor to be able to make its products visible and available to retailers even in the absence of pre-existing relationships and/or large-volume demands. A virtualized wholesaler as described herein can step in to fulfill orders efficiently even without pre-stocked product, and rapidly enough for the product to be on the retailer's in a just-in-time (JIT) fashion that benefits the manufacturer/vendor (who is freed from key constraints in finding an outlet), the wholesaler (who can promote sales without requiring substantial pre-stocking of products that may not have a large-volume presence), and the retailer (who can exploit long-tail economics to increase its variety of product offerings and reach specific, often niche consumers with reduced risk of dead shelf space).

Virtualized wholesaling may be able to take advantage of a wealth of information collected itself or gathered from retailers, vendors, and/or manufacturers in the form of sales, order, feedback, turnaround, and much other information to recognize and feed opportunities for retailer recommendations and relationships, and even to predict consumer demand and the ability to create, fulfill, and deliver orders in JIT fashion to meet demand. Eminently scalable, the service may enable an effectively unlimited number of manufacturers and vendors to list their products, collect orders from retailers, and make use of third parties to perform fulfillment. Accordingly, virtualized wholesaling as described herein need not be constrained by volume, warehousing, fulfillment services, or heavyweight contract concerns. Manufacturer, vendor, and retailer alike may mutually benefit from the information collected from their channels as described herein.

In addition, the data itself can be commoditized. In some embodiments, a large amount of data is gathered and/or generated for various purposes including those described herein, and its value can be extended to retailers, vendors, distributors, and the like for their own use. For example, data relating to product ordering and procurement, pricing, and demand at various times of year may be projectable and thus have value to existing retailer customers for future purchasing plans; hence, a data product can be produced from analyzing raw data for sale to the retailer customer to project or help with projecting future demand. Data products can also, in some instances, be interpreted and used to support a demand guarantee, future financial decisionmaking, and/or product insurance, among other things. In addition, or alternatively, the raw data itself can be prepared to be understood in a usable way, and sold even without analysis or implementing analytic software.

Throughout the description, “vendor” and “manufacturer” may be used interchangeably. The source of a product posted by the virtualized wholesaler may be the manufacturer of the product or a vendor acting on behalf of the manufacturer. In some instances, the manufacturer and the vendor are one and the same. Therefore, unless the context indicates otherwise, no distinction need be made between “vendor” and “manufacturer” to understand the disclosed concepts. Similarly, although “product” and “brand” may be used interchangeably, context may dictate a difference (such as a “brand” comprising one or more “products”). Similarly, “retailer” may be used interchangeably with “retailer customer” and represent not merely the traditional bricks-and-mortar retailer but also virtualized retailers, such as online retailers, retailers in AR/VR, and/or the like borne of technology past, present, and future without limitation. Also, “product” is understood to include the notion of a more general “product category”, such as baked goods, hardware, ingredients, dietary preferences, etc., or even categories within categories such as cookies (e.g., locally baked cookies within cookies within baked goods) or hardware (e.g., diamond-tipped drill bits within drill bits within hardware), etc.). No distinction need be drawn for the purposes of understanding the disclosed concepts unless context dictates otherwise.

In some scenarios, a product manufacturer or vendor may not have a steady business relationship or ready outlet to exploit in selling its products. For example, a vendor of a newly established or niche product may have difficulty making its product, or even its brand, known to enough retail establishments to fully participate in the market. A virtualized wholesaler may make an arrangement whereby the product may be posted online for discovery by a retailer in accordance with analysis to customize the posted product for the retailer's needs (more specifically, the needs of the retailer's customer). That arrangement may take the form of the virtualized wholesaler providing complementary applications (“apps”) to the retailer and vendor, analyzing a variety of data to reveal relationships among the data, and act on those relationships to the mutual benefit of the retailer and vendor. For example, the analysis performed by the virtualized wholesaler may reveal that a product sold by the vendor could find a buyer in the retailer's store. The retailer and vendor via their respective apps may provide some or all of that data to the virtualized wholesaler.

In some scenarios, the arrangement may help solve a vendor's dilemma: The vendor could self-distribute to retailers limited in number and size, or attempt to work with the traditional distributors using their systems and relationships established over years and unlikely to be adjusted to fit the needs of a small vendor. Taking those tasks in-house, though, might add an unwanted dimension to the vendor's business, making the vendor the manufacturer, vendor, and wholesaler. The disclosed virtualized wholesaler largely removes the wholesaling burden from the vendor and at the same time enables the vendor, via any of a variety of means, to access data, reporting, and analytics maintained by the virtualized wholesaler via a unified view with an integrated set of tools.

Certain activities on the vendor side also traditionally require substantial human involvement with concurrent skill. Demand management generally is an example. Inventory management, price management, and/or promotion/sales management may be statistically dependent variables in machine learning models for demand management. For a small vendor in particular, a customized tech-enabled distribution platform and product supply chain based on virtualized wholesaling as described herein provides an environment in which to grow and thrive.

Retailers have their own dilemmas, some of which may include the reality of margins as a driver for product ordering and placement. Small retailers in particular may cater primarily to regular customers who have their own unique and uniquely personal preferences and needs, and might be ideal for niche product offerings. However, while it may on occasion be possible to satisfy one customer requesting one niche product, the model may not scale due to constraints of storage space, shelf space, shelf life, and small margins. Even special requests may be unprofitable in a vacuum, and trying to satisfy multiple special requests can be so unprofitable that the small retailer may be obliged only to stock well-known brands that can be purchased from wholesale and easily stored, knowing that they will sell predictably enough for regular ordering and stocking. In turn, the wholesaler has no incentive to push niche products on the retailer because the wholesaler has its own constraints on space and the realities of supply and demand. This also reinforces the wholesaler's incumbent selection/planogram.

Virtualized wholesaling as described herein may provide retailers access to a wider number of niche products. However, this gives retailers, who are obliged to know and track products, ever more products to know and track, and ultimately to purchase and place. This is beyond the ability of the typical human buyer for retail stores. The disclosed virtualized wholesaling enables the retailer to proactively purchase and stock product based on data, not solely on the instincts of a human buyer. Note that the predictive analytics of the virtual wholesaler solution may take advantage of data not just for the store, but for similarly situated stores. A store in Seattle, Wash. may be similarly situated as a store in Columbus, Ohio, and the data analytics model may enable more accurate predictions as to what specific rotation of products for shelf space would maximize sales or maximize margin, for example.

In some embodiments, an advantage can be gained with a system that utilizes gathered data not just to recommend a product in response to historical demand or any specific retailer inquiry, but to determine when a particular product or product category might be successfully placed without retailer demand or inquiry. For example, the virtualized wholesaler is able to leverage its vast historical data gathered from past orders, sales, distributions, and/or other factors to reach out to a retailer with a recommendation to stock or even to introduce a particular product or product, optionally at a particular price point, size, volume, product quality, timing, and/or the like, without any request or inquiry by the retailer. The recommendation may be made in connection with or independently of any specific brand or brands (indeed, recommendations can be made without considering brands at all until the final result, optionally including brands, is made to the customer). In some embodiments, the virtualized wholesaler may determine what brand or brands to recommend after gathering, generating, and/or analyzing data, and only then recommend the brands to the retailer customer. For the virtualized wholesaler, these efforts are expertly tailored to a particular retailer's business needs, considering availability of brands, ability of brand manufacturers and/or suppliers to meet the parameters in support of the recommendation, external factors such as weather, trends, historical sales data, and/or the like. For the retailer, the virtualized wholesaler has performed all of the legwork to identify brands that fit the retailer's business needs and constraints, saving the retailer valuable time, energy and anxiety.

Virtualized wholesaling as described herein can enhance the relationship between wholesaler and retailer as well because the retailer may order any number of products, from small to large, with confidence that the product will sell based on trends in similar locations and telemetry related to past movement of product at certain price points. Further, the retailer has visibility to harness the wholesaler's analytics for judging the timing and amount of products to order, knowing that with JIT supply, the products will arrive when the retailer needs them because the wholesaler is able to stock the products before the retailer needs them. Thus, for the retailer, stocking management may be a statistically dependent variable for demand management.

In between, the virtualized wholesaler gathers information from retailers, vendors, distributors, trade publications, internally, indeed from any number of sources to generate and/or feed statistical or machine learning models including deep learning to aid in product promotion, vendor assistance, and JIT delivery to retailers. The virtualized wholesaler may guide the vendor, offering product posting with knowledge of when the product can or should be made available; promotion support by pushing product recommendations and/or brand recommendations to retailers based on projected demand; coordinated JIT service to provide transparency as to the ordering source(s), quantities to each, how and when to be delivered, etc. Many of these wholesaling services are driven by the mobile and web apps as the control panel but also as the window into the process, even as the virtualized wholesaler may maintain some features or play some roles of a legacy wholesaler, such as intake, storing, delivery to distributor, and/or the like. The virtualized wholesaler can also package this information into a data product to sell or better serve customers directly with risk mitigation resulting from data insights.

In one sense, the virtualized wholesaler may also provide a service of disintermediating itself from the vendor-retailer relationship in that the virtualized wholesaler may promote brands, not simply to have a stable of, say, chocolate cookies, but to have a niche chocolate cookie product unique to a brand that can give the brand a leg up in comparison with the myriad chocolate cookie providers with which the brand competes. Data modeling that leads to a posting for a specific brand or to a specific retailer to try a specific brand, pushed or returned in response to a search by that retailer and all based on data gathered from the many sources, may put that brand out front in a way that helps it maximize its potential. The information that feeds the data models is not available to or not utilized by legacy wholesalers or even online retailers, who at best provide a virtual shelf for niche products and nothing more. Virtualized wholesaling as described herein, on the other hand, may connect retailers or resellers with vendors in a way that, while mutually beneficial, boosts the vendor even as the retailer can provide a better customer experience.

In some embodiments, virtualized wholesaling may include receiving from a retailer data comprised of historical sales data, raw or as a dataset, the historical sales data including at least one attribute specific to the retailer; creating a machine learning data model based at least on the dataset or a dataset comprised of the raw data; and performing a prediction of a statistically dependent variable of the attribute(s) specific to the retailer. The data model prediction may be associated with a statistical level of confidence based on the accuracy of the model over time. In some embodiments, the accuracy of the model may be based on predictions over time meeting a predetermined tolerance or precision. For example, if the prediction (dependent variable) is of a change in demand for a product and the attribute(s) (independent variables) include sales of a constituent product over a period of one week, and if the retailer sets a threshold of change in demand of five sales of the constituent product in one week before ordering the product, then an order for the product may be placed with the vendor upon the data model predicting the change in demand based on the constituent sales data and the threshold (i.e., the constituent sales data meet or exceed the threshold).

In some embodiments, the prediction of a change in demand may include a corresponding amount of product that the retailer will need by a specific date. In other embodiments, a separate data model or models may generate a prediction of the necessary amount of product based on historical data relating the predicted change in demand with the amount of the constituent components sold and/or number of constituent component sales in order to meet the required date. All predictions may be associated with respective statistical levels of confidence and may be packaged into different risk levels, risk profiles, or data products.

In some embodiments, the virtualized wholesaler may relate the predicted change in demand with the availability of the product in the quantity predicted to be ordered by the retailer and needed by a specified date. In some scenarios, the virtualized wholesaler may then place an order with the vendor and post the product on the virtualized wholesaler's website or the like, even before the retailer enters its order with the virtualized wholesaler. Because of the prediction, the virtualized wholesaler is able to anticipate the retailer's need for the product and make it available for purchase, shipping, and delivery at the time required by the retailer, all based on the dataset and data models.

In addition or alternatively, data may be gathered from multiple retailers, vendor(s), and/or third parties (such as industry data or trends). Data can also be sourced by the virtualized wholesaler's history of predictions, sales, orders, deliveries, and/or feedback. Datasets may be compiled by the virtualized wholesaler or input to models as received. Indeed, the virtualized wholesaler may be considered a distribution platform as well as a product wholesaler, matching retailers with brands by leveraging transactional procurement data. In some embodiments, the virtualized wholesaler may also be able to route workflows to a network of third-party logistics providers for consolidated order fulfillment.

In some embodiments, the analyzed data, and even the data models, can be commoditized. As described herein, in some embodiments the virtualized wholesaler may generate datasets from various data from previous sales and sales environment conditions. The datasets can be used to develop and train data models for use in forecasting trends, demand, manufacturing, distribution constraints, and/or the like. Then, the data models can be fed current data to produce output forecasting and recommendations to be matched with product and/or brand availability. Through feedback, the data models can also be updated or supplemented with other data models, applied in parallel or serially, to improve forecasting and recommendations. The data models themselves then may become sales products (data products) for possible sale or licensing to retailer customers (e.g., to aid with their future purchase planning), vendors (e.g., to forecast demand, ingredient or component need, and set cost-of-goods expectations), or others inside or outside the supply chain (e.g., trend analysts).

With all of these services, the virtualized wholesaler is able to connect uniquely brands and retailers using data collected from, e.g. and without limitation, retailers, vendors, and/or other sources about products, product procurement, and consumer demand (indeed the evolving competitive environment in retail), to better inform targeted sales, brand growth, and right-sizing inventory—in motion—in just-in-time fashion.

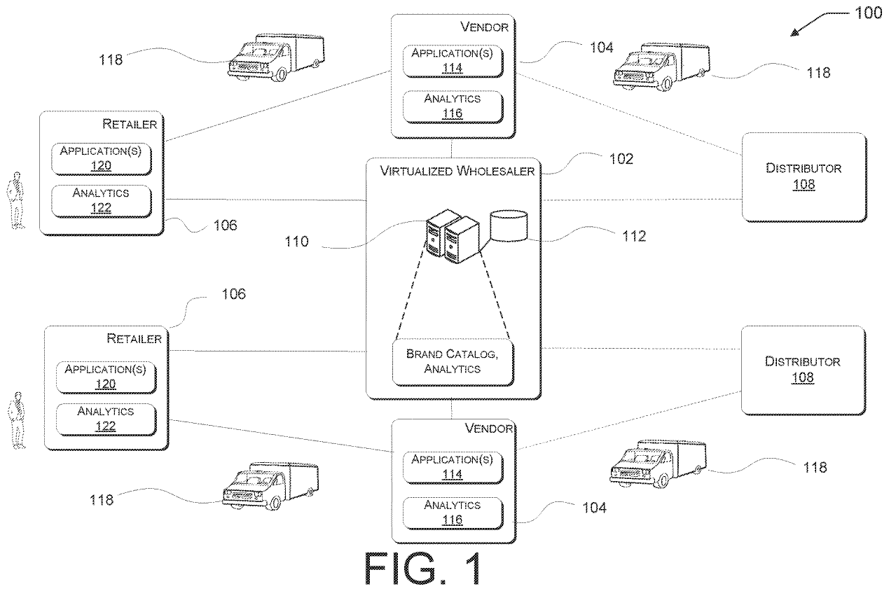

FIG. 1 illustrates an example architecture 100 for implementing a platform that matches retailers with vendors. The example architecture 100 may include a virtualized wholesaler 102, one or more vendors 104, one or more retailers 106, and one or more distributors 108.

The virtualized wholesaler 102 is generally a wholesaler for the architecture 100. The virtualized wholesaler 102 may be provided with various resources for the likes of managing product availability, controlling order fulfillment, and/or communicating with, and generally providing support for, the vendor(s) 104 and retailer(s) 106. Virtualized wholesaling in accordance with embodiments described herein is not limited to facilitating the brand-retailer relationship with regard to any particular product. The virtualized wholesaler 102 may be used as a hub via which retailers and vendors may coordinate orders and sales. For example, the virtualized wholesaler 102 may receive one or more orders from a retailer 106; or one or more products, or information of one or more products, from a vendor 104. The virtualized wholesaler 102 further may receive a variety of data from one or more of the retailers 106, one or more of the vendors 104, and/or one or more of the distributors 108; process and analyze the data, and in general provide services such as predictive and other analytics as described herein.

The virtualized wholesaler 102 may include one or more servers 110 and a data store 112. The server(s) 110 may include one or more network servers configured with hardware, software, and/or firmware that perform one or more of ingesting content, processing and analyzing the content, making the analysis results available for consumption, and controlling personnel and apparatus in accordance with the results, as discussed more fully below.

The data store 112 may store, for example, various data collected by the virtualized wholesaler 102, the vendor(s) 104, and/or the retailer(s) 106. The data may also have been obtained from other sources such as trade associations, municipal agencies, research organizations, and/or the like. The data store 112 may be contained within the server 110, separately but at least partially within the server 110, or externally of the server 110 as shown in FIG. 1. In some embodiments, the data store 112 may be disaggregated in, e.g., cloud storage. The data store 112 is not limited as far as the data and/or information stored therein. For example, the data store 112 may store data in raw, addressable form or in one or more databases, such as relational databases.

In some embodiments, the vendor(s) 104 may have or have access to one or more application(s) 114. The application(s) 114 may be configured to facilitate or perform a variety of operations, including but not limited to managing orders and inventory via a dashboard, thereby providing visibility into each step of the process from order to fulfillment with customizable granularity; optimizing growth (production, marketing, inventory, etc.) using real-time data and analytics provided by the virtualized wholesaler 102; and optimizing ordering, logistics, and consolidated deliveries by operation from a single source. Examples of real-time data and analytics may include analyzing historical data of purchases, deliveries, trends, and the like collected themselves or obtained from the retailer(s) 106, the virtualized wholesaler 102, or another source.

In some embodiments, the vendor(s) 104 may be goods producers or procurers. As procurers, the vendor(s) may, in some embodiments, control production of the goods (products) by other parties. The application(s) 116 may comprise hardware, software, and/or firmware, software and firmware being executable by one or more processors of computing device(s) implemented by the vendor(s) 104 in some embodiments. In these or other embodiments, products that are produced or obtained by the vendor(s) 104 may be delivered to the retailers 106 or other entities via a delivery vehicle 118 such as, without limitation, a truck as shown, a drone, or another vehicle. In some examples, deliveries may be made on foot.

The retailer(s) 106 may be physical (so-called “bricks-and-mortar”) stores, in some embodiments. A reseller (e.g., one that obtains products from a virtualized wholesaler for resale to a retailer) may be regarded as a retailer for the purposes of this disclosure. The retailer(s) 106 may have or have access to one or more application(s) 120 configured to perform or facilitate operations that may include, without limitation, product management (e.g., ordering, inventory, payment, and/or delivery) via a dashboard; optimizing in-store sales using real-time data and analytics provided by the virtualized wholesaler 102; and/or sourcing products from one source (e.g., the virtual wholesaler 102) regardless of vendor or reseller. Product management may include receiving product offerings, managing pricing and promotions in real time, placing orders, and/or controlling payments, in some instances using real-time analytics 122, for example, by analyzing historical data of purchases, deliveries, trends, and the like collected themselves or obtained from the vendor(s) 104, the virtualized wholesaler 102, and/or another source. The application(s) 122 may comprise hardware, software, and/or firmware, software and firmware being executable by one or more processors of computing device(s) implemented by the retailer(s) 104 in some embodiments.

The distributor(s) 108 may be one or more entities that receive orders from, e.g., the vendor(s) 104 and/or the virtualized wholesaler 102 for delivery of products, typically to the retailer(s) 106 as directed by the vendor(s) 104 and/or by the virtualized wholesaler 102 via the delivery trucks 118 or other examples as outlined elsewhere herein. In some examples, the distributor(s) 108 may deliver the ordered products to the vendor(s) 104 or another entity rather than directly to the retailer(s) 106. In some examples, the vendor(s) 104 may be the distributors of products, including products produced by the vendor(s) themselves.

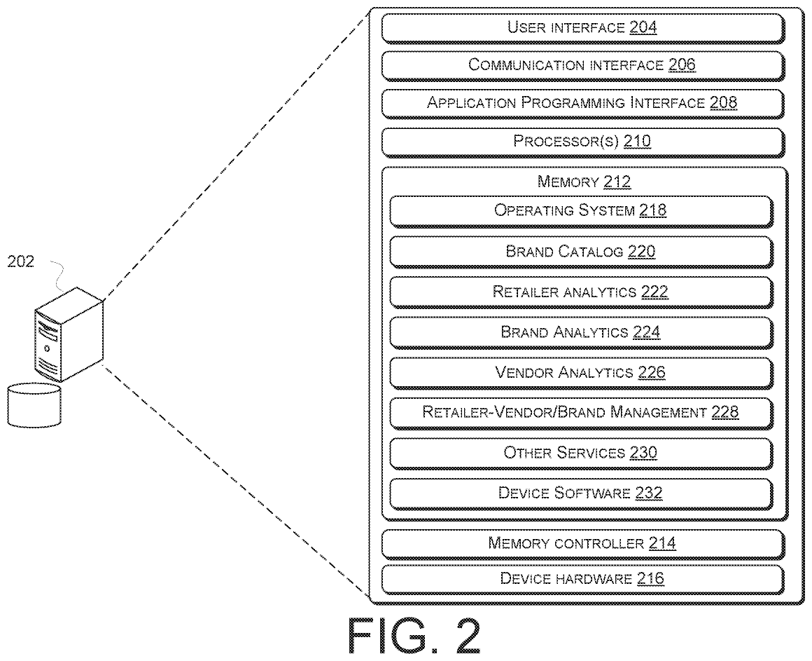

FIG. 2 illustrates various components of a server 202 that implements virtualized wholesaling. The server 202 may be configured with hardware, software, and/or firmware to, among other operations, communicate with the vendor(s) 104, retailer(s) 106, and distributor(s) 108; enable the vendor(s) 104 to list their products, collect orders from the retailer(s) 106, and make use of third parties to fulfill those orders; provide the retailer(s) 106 with easy access to a variety of products including newly established products or niche products; gather data and perform predictive analytics on the data, enabling the retailer(s) 106 to proactively purchase and/or stock product based on data and not the instincts of a human buyer. The server 202 may represent and correspond to the server(s) 110 of the virtualized wholesaler 102 illustrated in FIG. 1, and in the nonlimiting example shown includes a user interface 204, a communication interface 206, an application programming interface 208, one or more processors 210, memory 212, a memory controller 214, and device hardware 216.

The user interface 204 may enable a user to provide input and receive output from one or more of the vendor(s) 104, the retailer(s) 106, and the distributor(s) 108. The user interface 204 may include a data output device (e.g., visual display, audio speakers), and one or more data input devices. The data input devices may include, but are not limited to, combinations of one or more of touch screens, physical buttons, cameras, fingerprint readers, keypads, keyboards, mouse devices, microphones, speech recognition packages, and any other suitable devices or other electronic/software selection methods.

The communication interface 206 may include wireless and/or wired communication components that enable the server 202 to transmit data to and receive data from other networked devices via the communication network. In some embodiments, the communication network may be a wired and/or wireless communication network, including but not limited to cellular networks, the Internet, and/or other public and private networks, including LANs, WANs, VPNs, and/or other networks internal to the virtualized wholesaler 102

The application programming interface (API) 208 may enable communications between the server 202 and one or more of the vendor(s) 104, retailer(s) 106, and distributor(s) 108 over the communication network via the communication interface 206. The API 208 may, among other features, define the format of data and instructions received and sent by the virtualized wholesaler 102, abstracting other components of the server 202 and internal layers of the server 202 in general, and extend functionality without exposing objects and services absent pre-existing permissions.

The processor(s) 210 and the memory 212 may implement an operating system 218 stored in the memory 212. The operating system 218 may include components that enable the server 202 to receive and transmit data via various interfaces (e.g., the user interface 204, the communication interface 206, and/or memory input/output devices), as well as process data using the processor(s) 210 to generate output. The operating system 218 may include a display component that presents output (e.g., display data on an electronic display, store the data in memory, transmit the data to another electronic device, etc.). Additionally, the operating system 218 may include other components that perform various additional functions generally associated with an operating system.

The memory 212 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, Random-Access Memory (RAM), Dynamic Random-Access Memory (DRAM), Read-Only Memory (ROM), Electrically Erasable Programable Read-Only Memory (EEPROM), flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer readable storage media do not consist of, and are not formed exclusively by, modulated data signals, such as a carrier wave. In contrast, communication media may embody computer-readable instructions, data structures, program modules, or other data in a modulated data signal, such as a carrier wave, or other transmission mechanism.

The memory controller 214 may include hardware, software, or a combination thereof, that enables the memory 212 to interact with the communication interface 206, processor(s) 210, and other components of the server 202. For example, the memory controller 214 may receive data or instructions from the communication interface 206 and store the same in the memory 212, and/or send the received data or instructions to the data store 112. In some embodiments, the memory controller 214 may retrieve instructions from memory 212 for execution by the processor(s) 210.

The device hardware 216 may include additional hardware that facilitates various device functions performed by the server 202.

The memory 212 may, in addition to the operating system 218, store various software such as, without limitation, a brand catalog 220, retailer analytics 222, brand analytics 224, vendor analytics 226, a retailer-vendor/brand management module 228, other services 230, and device software 232. The software may include computer-executable instructions that, if executed by the processor(s) 210, cause the processor(s) 210 to perform various operations.

The brand catalog 220 may be storage for product information, and in particular for information on products available from individual vendor(s) 106. In this sense, the brand catalog 220 may represent a virtual catalog of products for each vendor, whether the vendor be the brand, a manufacturer of the brand, or any other breakdown associated with the product. In some examples, a brand manufacturer as a vendor may have its products managed by the virtualized wholesaler 102 in the brand catalog 220 so that products can be posted for viewing and/or ordering by a retailer 104. The products may be organized to be retrievable by product name, brand name, or any suitable search query, and managed accordingly. The brand catalog 220 for any particular brand or vendor may include products or brands not currently posted for the retailer 104, and may instead be posted in accordance with specific requests or in accordance with chosen search terms, filters/tags, order history, or predictive analytics as discussed elsewhere herein.

The retailer analytics 222 may comprise computer software, firmware, or hardware, of a combination of these, and may analyze data including, without limitation, purchase and sales data, order data, delivery data, customer feedback, trend analysis, supply data, catalogs, and the like, and/or data resulting from analyzing any of these, compiled by or on behalf of retailers 106 individually. The retailer analytics 222 may analyze aspects of retailers on an individual basis with any desired granularity. For example, the retailer analytics 222 may derive correlations between and among data points in the analyzed data to be added to one or more machine learning data models created and/or implemented by the retailer-vendor/brand management module 228.

The brand analytics 224 may analyze data including, without limitation, purchase and sales data, order data, delivery data, customer feedback, trend analysis, supply data, catalogs, and the like, and/or data resulting from analyzing any of these, compiled by or on behalf of brands individually. The brand analytics 224 may analyze aspects of brands on an individual basis with any desired granularity. For example, the brand analytics 224 may derive correlations between and among data points in the analyzed data to be added to one or more machine learning data models created and/or implemented by the retailer-vendor/brand management module 228.

The vendor analytics 226 may analyze data including, without limitation, purchase and sales data, order data, delivery data, customer feedback, trend analysis, supply data, catalogs, and the like, and/or data resulting from analyzing any of these, compiled by or on behalf of vendors 104 individually. In some embodiments, one or more of the vendors 104 may be the brand producers and/or sellers themselves. The vendor analytics 226 may analyze aspects of the vendors 104 on an individual basis with any desired granularity, such as per product, per SKU, and/or the like. In some examples, the vendor analytics 226 may derive correlations between and among data points in the analyzed data to be added to one or more machine learning data models created and/or implemented by the retailer-vendor/brand management module 228.

The retailer-vendor/brand management module 228 may include one or more data models and/or machine learning modules for training the data models using datasets derived from data provided by the vendor(s) 104, retailer(s) 106, distributor(s) 108, and/or other sources, including data created, collected, or held by the virtualized wholesaler 102 itself. In some examples, the training dataset may be data compiled for an individual brand. The data may, for example, include data as independent variables (e.g., time of year or cost of goods sold data) and data as dependent variables (e.g., gross sales or sales by location). One or more data models may be chained so that values of dependent variables output by one data model may be fed as independent variables to a subsequent data model. The data may be internal data including, but not limited to, any of the data gathered, analyzed, generated, compiled, and/or collected by one or more of the vendor(s) 104, retailer(s) 106, distributor(s) 108, the virtualized wholesaler 102, or by any other source(s).

In making the vendor's products visible to retailers, the retailer-vendor/brand management module 228 may utilize machine learning modules to determine, or predict, specific brands of a product manufactured and/or sold by the vendor. For example, the retailer-vendor/brand management module 228 may develop data models that input retailer datasets of inventory, sales, and/or other information; brand datasets of new product offerings, production constraints, and/or supply chain considerations; vendor datasets of product availability, turnaround time, and/or other information; and/or virtualized wholesaler datasets of stock, product expiration, retailer, brand, vendor, and/or product analytics, and output predictions of newly established products or niche products that may sell within a specified time period. In some embodiments, the retailer-vendor/brand management module 228 may utilize machine learning modules that train one or more data models using initial datasets and results of inputting specific independent variables to any level of granularity desired (e.g., time of year; day of week; proximity to business environments, entertainment establishments, or neighborhoods; type of packaging; location demographics, and so on), deriving a prediction of various product sales from the data model(s), and output the prediction (more specifically, one or more dependent variables such as sale of a specific product, number of sales, timing of sales, and/or the like) with an associated statistical confidence level. The statistical confidence level may be required to meet or exceed a threshold, which may be predetermined for one or more of the dependent variables, in order for the output values to be considered reliable and thus implemented in the virtualized wholesaler's decisionmaking.

In some embodiments, deciding to recommend or directly list products (e.g., vegan cookies, environmentally friendly paint, pH-balanced pet shampoo, XYZ Winery merlot, etc.) may make the products visible directly to retailers whether or not the retailers 106 specifically request a product, category of product, or any other request via its application 120. In addition, or in the alternative, the virtualized wholesaler 102 may push product recommendations to the retailer(s) 106 based on outputs of the data model, without the retailer realizing the benefit of carrying such products. Beyond allowing retailers 106 visibility into the products, vendors 104 may also have improved visibility into the exposure of their products and interest in their products, including but not limited to sales made to any number of individual retailers 106 (even if not via the virtualized wholesaler 102), the feedback of which may be added to the dataset(s) and result in the products becoming used in the virtual wholesaler solution's data models. In some embodiments, sales to one or more retailers 106 added to the dataset(s) and run on the data model(s) may result in the virtualized wholesaler 102 surfacing the product to other retailers 106, based at least in part on the sales of the product to such retailer(s), thereby aiding in the growth of the product or brand and, in turn, its manufacturer.

Data modeling may also include performing a prediction of a change in a variable that is statistically dependent on the predicted demand. For example, the virtualized wholesaler 102 may receive from a retailer 106 a dataset, or data to be added to a dataset, relating to historical sales that includes at least one attribute (e.g., a statistically independent variable) specific to the retailer 106. The data, alone or aggregated with historical data in the dataset (which may include data from other retailers), may be partitioned into data partitions based on the at least one attribute specific to the retailer 106. In this example, the virtualized wholesaler 102 may create a machine learning data model based at least on a data partition from the dataset to output a prediction of a change in the attribute as a statistically dependent variable specific to the retailer 106.

In some embodiments, the output or outputs of the data model(s) enable the virtualized wholesales 102 to enhance the relationship between the retailer and vendor to the extent that the models are tuned to output information for logistics to ensure JIT delivery to the retailer(s) 106, whether or not the retailer has requested a specific delivery or even, in some instances, whether or not the retailer has even yet placed an order. The retailer may order any number of products, from small to large, with confidence that the product will arrive timely and sell. Further, the retailer has visibility via its app to harness the wholesaler's analytics for judging the timing and amount of products to order, knowing that with JIT supply, the products will arrive when the retailer needs them because the wholesaler is able to stock the products when the retailer needs them. Thus, for the retailer, stocking management may be a statistically dependent variable for demand management. Concomitantly, with the information gathered from retailers, vendors, distributors, trade publications, internally, indeed from any number of sources to generate and/or feed machine learning models to aid in product promotion, vendor assistance, and JIT delivery to retailers, the virtualized wholesaler 102 may guide the vendor, offering product posting with knowledge of when the product can or should be made available; promotion support by pushing product or product category recommendations to retailers based on projected demand; coordinated JIT service to provide transparency as to the ordering source(s), quantities to each, how and when to be delivered, etc.

Other services 230 may include wholesale workflow management services such as product intake, storage, and shipping, and coordinating the same; payment and financing; third-party applications; dataset integration; and/or other services associated with product wholesaling, especially those tailored to JIT delivery of products to the retailer(s) 106. In this regard, JIT servicing is not simply about logistics; the disclosed virtualized wholesaling can ensure that the wholesaler has the product in stock so that the retailer has the product in stock when the retailer needs it, fueled by predictive analytics and working the supply chain accordingly.

The device software 232 may include software components that enable the server 202 to perform typical server functions. For example, the device software 232 may include a basic input/output system (BIOS), Boot ROM, or bootloader that boots up the server 202 and executes the operating system 218 following power up of the server.

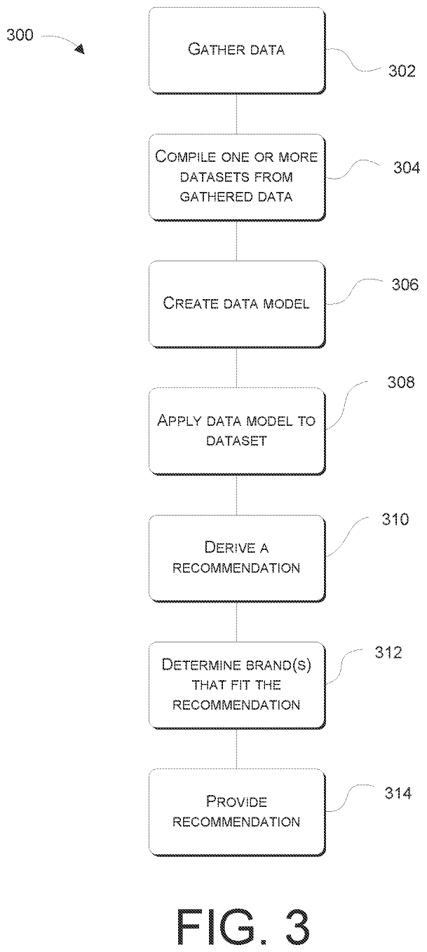

FIGS. 3-5 present illustrative processes 300, 400, and 500, respectively, for implementing virtualized wholesaling. Each of the processes 300, 400, and 500 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 300 and 400 are described with reference to the architecture 100 of FIG. 1.

FIG. 3 is a flow diagram of an example process 300 performed at least in part by the server 202 for implementing product and/or brand recommendations to a retailer. In some embodiments, the process 300 may output a simple brand recommendation as a result of brand-agnostic computations to first reach a product or product category recommendation, and then to determine a brand or brands that meet parameters that fit a particular retailer's needs.

At block 302, the server 202 may gather data from one or more retailers, vendors, distributors, trade publications, weather reports, news publications, and/or the like. The number and type of sources are practically unlimited. The gathered data may include data compiled by or already housed by the virtualized wholesaler, for example from its own prior research and/or business activity. The data may be of any sort (for example raw or processed, structured or unstructured, etc.) and categorizable a practically unlimited number of ways.

At block 304, the server 202 may compile one or more datasets from the gathered data. In some embodiments, one or more of the datasets may be useful as training datasets to train machine-learning data models as described elsewhere herein. A dataset may comprise data of a particular retailer, brand, product, product category, and/or the like such that, if fed into an appropriate data model will produce an output that either indicates a desired result or can be used to find a desired result. For example, a chosen dataset may contain data relevant to making product recommendations for a retailer.

At block 306, the server 202 may create a data model for providing a result (a dependent variable such as a recommended product) based on input of one of the datasets (comprising one or more independent variables such as season of the year, neighborhood of a retailer, and/or the like). The data model can be created by finding a best fit algorithm for a chosen dataset (known as a “training dataset”) and then adjusting the algorithm until the output is within a threshold of satisfaction. In some scenarios, the data model may be a product itself, to be potentially sold or licensed for use by a retailer, analyst, or other to find a result based on its own data input.

At block 308, the server 202 may apply the data model to one of the datasets. This dataset typically includes data points chosen as independent variables deemed to inform a reliable result to whatever end the data model was created. Some examples of the data model may have been developed to determine a timeframe for peak demand of a certain product based on historical foot traffic to a particular retailer and trend data gathered by the virtual wholesaler, or to determine a product to be recommended to a retailer based on demographic changes in the vicinity of the retailer combined with a current surge in US-made products of a similar type. In some embodiments, the types of data model are limited only by the needs identified by the virtualized wholesaler and the number of data models is practically limitless.

At block 310, the server 202 may derive a recommendation from the data model output. The recommendation may be of a product, product category, or brand, for example. In some embodiments, the recommendation may be “realized” or “recognized” by the data model, or by a person interpreting the output of the data model in conjunction with other information not fed to the data model (such as current road conditions, temporary closing of the retail store due to a facility infrastructure problem or the owner being away on vacation, anecdotal success of a product at similar establishments in similar remote locations, and so on), without input from the retailer other then any data included in the dataset. The recommendation may be brand-agnostic (vegan cookies) and/or nonspecific (fresh fruit).

At block 312, the server 202 may determine a brand or brands that fit the recommendation. For example, the data model may output a recommendation for a particular retailer to stock vegan cookies and, with constraints of shelf space, cost of ingredients, foot traffic at the retailer, and/or other factors, the server 202 may take the determination and be able to identify one or more brands recorded in a database that meet all criteria. In some embodiments, these results may be informed or filtered by human input. Accordingly, the recommendation may be for a particular brand of a particular product for a particular retailer to stock at a particular time.

At block 314, the server 202 may provide the recommendation to the retailer. In some embodiments, the recommendation may be a particular brand, surfaced via an app viewable by the retailer, who may have no knowledge of the analysis that went into making the recommendation, or even know that a recommendation was forthcoming. The recommendation may take any suitable form, such as a picture of the product and hyperlink to place the order, and may be accompanied by other recommendations such as when to stock

In some embodiments, the analyzed data, and even the data models, can be commoditized. As described herein, in some embodiments the virtualized wholesaler may generate datasets from various data from previous sales and sales environment conditions. The datasets can be used to develop and train data models for use in forecasting trends, demand, manufacturing, distribution constraints, and/or the like. Then, the data models can be fed current data to produce output forecasting and recommendations, to be matched with product and/or brand availability or to place orders on the retailer's behalf automatically, for example. Through feedback, the data models can also be updated or supplemented with other data models, applied in parallel or serially, to improve forecasting and recommendations. The data models themselves then may become sales products (data products) for possible sale or licensing to retailer customers (e.g., to aid with their future purchase planning), vendors (e.g., to forecast demand, ingredient or component need, and set cost-of-goods expectations), or others inside or outside the supply chain (e.g., trend analysts). Similarly, the datasets run through the data models may be data products. Other data products may include raw data underlying the datasets, analyzed and/or interpreted data model output, advanced data analytics, and/or a planogram to help the retailer optimize shelf space and presentation given a known strategic direction, test strategies in the store (such as, and without limitation, introducing a luxury product with a staple product in the same category in the same or different placement).

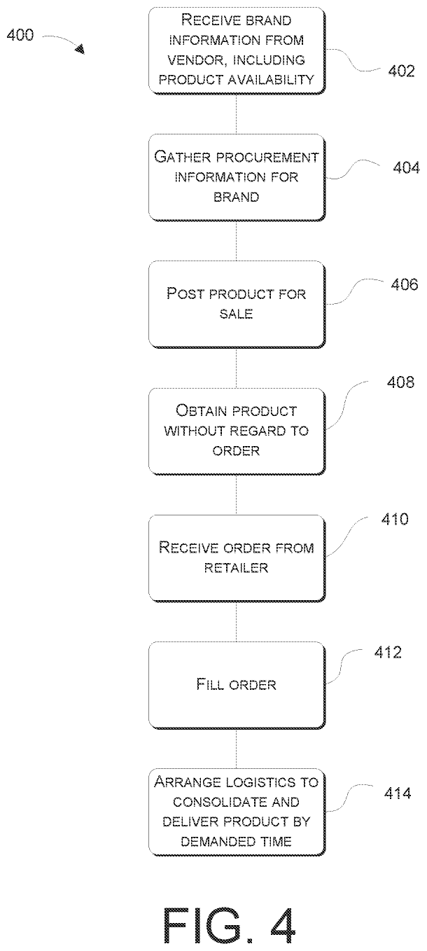

FIG. 4 is a flow diagram of an example process 400 performed at least in part by the server 202 for implementing virtualized wholesaling of a vendor's product offerings. In some embodiments, the process 400 may be brand-specific, i.e., performed on behalf of a brand to provide transparency in JIT wholesaling support for the brand.

At block 402, the server 202 may receive brand information from a vendor 104. The brand information may include, for a product, one or more of brand name, quantity or size, date of production, date available for delivery to the virtualized wholesaler 102 or to a retailer 104, expiration date, and/or the like. In this context, “brand” may refer to a product manufacturer, procurer, provider, or a product itself. In some examples, the brand may be a product that is not regularly stocked by the virtualized wholesaler 102, such as a niche product like craft cookies from a singular kitchen or bath salts of a unique blend of ingredients.

At block 404, the server 202 may gather procurement information for the brand. Procurement information may include recent and historical information regarding retail orders (e.g., quantity, timing, retailer location), time required at each interval in the supply chain (e.g., order to vendor, transport of product from vendor to virtualized wholesaler, from wholesaler to distributor, and from distributor to retailer), wildcards (difficult-to-project variables such as weather, ingredient shortages, personal situations on the vendor side such as illness, vacation, family emergency), and the like that inform the overall process of procuring products for JIT stocking. Procurement information may include data collected by the virtualized wholesaler 102 as well as data gathered from the vendor(s) 104, retailer(s) 106, distributor(s) 108, and/or other sources.

At block 406, the server 202 may post a product for order. In some embodiments, posting the product may involve predictive analytics that feed the JIT process, including timing the order for production, receiving the product for stocking, and sending the product out for delivery to the retailer 106 for placement on the shelf. The JIT process aims to reduce to the extent possible the time at the virtualized wholesaler 102, time on the shelf, and transit time from vendor to retailer. Thus, it can be said that the retailer's store is optimized for consumer demand as the predictive analytics incorporate demand forecasting as well as supply forecasting, and also may, in some embodiments, incorporate consumer or partner feedback regarding factors such as packaging attributes, shipping concerns, and the like. Feedback may be direct feedback to the data model(s) for fine-tuning, or may be expressed in output reports to be distributed, e.g., for human review. Such reports may aid with sales and trend analysis as well as to monitor the quality of the predictive outputs.

At block 408, the server 202 may obtain the product from the vendor 104 regardless of whether a retailer 106 placed an order. By utilizing the predictive analytics with machine learning, the virtualized wholesaler 102 is able, with a statistical confidence, place an order for a particular product by a particular brand, however niche, and have it delivered to a retailer 106 in JIT fashion with the goal of reducing the product's shelf time to the greatest extent possible. In some embodiments, this will entail systemic knowledge of factors such as time of consumer demand at a particular store, knowledge of a vendor's ability to produce the product and how quickly, and knowledge of logistical factors such as distributor availability, transit conditions, etc.

At block 410, the server 202 may receive an order from a retailer 106 for the product. In some embodiments, the order is received from the retailer after the virtualized wholesaler 102 has placed the order with the vendor. Using the predictive analytics, the virtualized wholesaler 102 is able to project with a statistical confidence the likelihood that the product in question will be ordered with a particular delivery date/time requested, and so place the order with the vendor 104 sufficiently ahead of the time for delivery to the retailer 106. Likewise, with transparency into the needs of the retailer 106, the vendor 104 is able to use its own predictive analytics to ensure that the necessary ingredients, packaging, staffing, etc. are in place to create the product in time to meet the anticipated order.

At block 412, the server 202 may fill the order for sending to the distributor 108. In this regard, the order may be actually filled (e.g., received, offloaded, counted, marked, stocked, removed from stock, marked for sending, loaded, and sent) by personnel, robotics, or a combination of the two, with the server 202 having control over one or more functions related to the order fulfillment.

At block 414, the server 202 may arrange the logistics of sending the product to a distributor 108 and delivering the product to the retailer 106. The logistics may include, without limitation, consolidating orders for the same retailer 106 so that the delivery of multiple, unrelated orders are fulfilled and delivered at once while honoring the JIT objective to the extent possible. Although the JIT objective is a considerable feature, it is noted that some retailers insist on, or at least favor, consolidated deliveries so as to reduce the staffing, complexity, and inconvenience of receiving multiple truck deliveries at the same time or throughout the day. By contrast, as described herein enables even niche products to enjoy the advantages of consolidated delivery, including but not limited to making available a larger variety of retailers from small businesses to large, even global, enterprises.

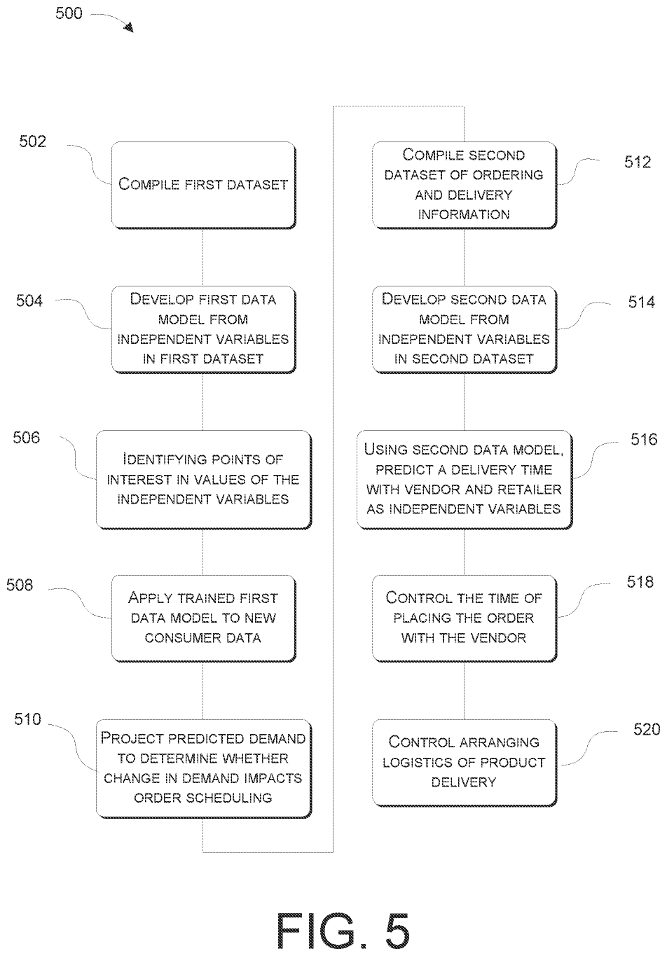

FIG. 5 is a flow diagram of an example process 500 performed at least in part by the server 202 for implementing predictive analytics and machine learning, with the goal of delivering a product to a retailer 106 as nearly as possible to a projected need date, thereby reducing if not minimizing time on the shelf or in store inventory. As is the case with respect to the process 400, in some embodiments, the process 500 may be brand-specific, i.e., performed on behalf of a brand to provide transparency in JIT wholesaling support for the brand.

At block 502, the server 202 may compile a dataset for input to a data model. The dataset may comprise historical retail sales data of various products, consumer behavior/tracked data, and/or brand-specific e-commerce data for brands sold directly to the consumer, to include values of one or more independent variables specific to an identifiable first retailer. The historical retail sales data may include sale dates and sale times for an individual product or for multiple products. The consumer behavior/tracked data may be gathered or collected using cookies and/or other technology to determine interests of the consumer based, e.g., on time spent on a page; hovering position of a cursor over a product, text, or advertisement; click-throughs; instances of returning to a page, etc. Brand-specific e-commerce data for brands sold directly to the consumer may be gathered or collected from any of a variety of third-party sources including trade publications, brand manufacturers, or from the virtualized wholesaler's own data, including data derived from point-of-sale, e-commerce, and other purchases, and/or other store or brand data, to augment the virtualized wholesaler's platform data. In some embodiments, the dataset may be compiled from retail sales information provided by, e.g., any combination of the vendor(s) 104, retailer(s) 106, and/or other sources, including data retained by the virtualized wholesaler itself.

At block 504, the server 202 may develop a data model using data from the dataset as one or more independent variables. In some embodiments, the data model may be a trained machine language (ML) data model trained from the dataset, and predicts a change in demand for the product based on the values of the one or more independent variables in the first dataset. For example, and without limitation, independent variables chosen for predicting Brand P chocolate cookie sales may be season of the year, trending sales in sugar-free cookies, and sales during school hours and outside of school hours. In another example, independent variables chosen for predicting sales of Brand E bath salts may be recent sales of scented candles and streaming movies.

At block 506, the data model may be trained using temporal data. In some embodiments, one or more points of interest in the values of the independent variables related to changes in demand for the first product may be identified. For example, and without limitation, sharp changes in recent sales of sugar-free cookies may coincide with a drop in orders for chocolate cookies by Brand P. If the model does not reflect the coincidence accurately (e.g., if the model predicts movement in the dependent variable of sales lag to order with an accuracy that fails to reach a threshold), training will continue until the model consistently reaches the threshold, in turn achieving a minimum statistical confidence.

At block 508, the server 202 may apply the data model to new consumer data corresponding to the independent variables. In some embodiments, applying the data model may include performing a prediction of demand for the product based on the identified one or more points of interest. In some instances, the data model may be applied to consumer data gathered from a specific retailer 106 with respect to a product of a specific brand (e.g., Brand P chocolate cookies).

At block 510, the server 202 may project the predicted demand to determine whether a change in demand may impact a schedule of ordering the product from the vendor 104 to meet the ensuing need of the retailer 106. For example, the product may be trending in similar locations suggesting a change in demand, tied to or in addition to how quickly the product will move on and off the shelf at certain price points. Projecting how quickly the product will move off the shelf can be predicted with specific degrees of certainty in accordance with a properly trained data model as described elsewhere herein. In some embodiments, a change in demand may call for a delay in ordering, e.g., the Brand P chocolate cookies from the retailer 106 in order to meet a JIT demand.

At block 512, the server 202 may compile, from ordering and delivery information of past orders from the retailer(s) 106 for the product from the vendor 104 using the distributor(s) 108, a second dataset comprised of, e.g., historical ordering and receiving data for the vendor 104, historical delivery data of that product from the vendor 104 to various retailer(s) 106, and values of one or more independent variables specific to the vendor and the retailer. In some embodiments, the historical ordering, receiving, and delivery data may include the success of meeting requested or projected times of delivery of the product to the retailer. The data also, or alternatively, may include data from other, similarly situated vendor(s) and/or retailers for similar products.

At block 514, the server 202 may develop a trained second data model from one or more independent variables in the second dataset that predicts an optimized delta between expected delivery time and actual delivery time of the first product to the first retailer. An optimized delta corresponds to a delivery that most closely meets the expected or requested delivery time; predicting the optimized delta thus predicts how close the supply chain may come to meeting the expected delivery time. In some embodiments, the independent variables fed into the second data model may include, without limitation, amount of product ordered, timing (time of year, time of day, proximity to weekend or holiday), available ingredients, and/or the like. Thus, the prediction may be made without regard to the time of any particular order to be delivered, meaning that the prediction is based on other factors such as, and without limitation, changes in ordered amount, difference in timing (time of year, time of day, proximity to weekend or holiday), change in available ingredients, and/or the like.

At block 516, the server 202 may, using the second data model, predict a delivery time of the product to the retailer 106 based on the vendor 104 and the retailer 106 as independent variables. Various other independent variables may be selected in addition or in the alternative. However, if the second data model is trained to a high degree of statistical confidence, the second data model would be expected to output a delivery time that can be relied upon to be correspondingly accurate.

At block 518, the server 202 may control the time of placing the order with the vendor 104 on behalf of the retailer 106 in accordance with the prediction of the first data model based on the change in demand meeting the point of interest. In some embodiments, the server 202 may receive a direct order from the retailer 106 for the product, and place the order with the vendor 104 in response to the retailer's order and in accordance with the JIT needs of the retailer 106. In other embodiments, the server 202 may place the order with the vendor 104 in advance of receiving the order from the retailer 106, or even without receiving such an order, in accordance with a business arrangement and predictive metrics described elsewhere herein.

At block 520, the server 202 may control arranging the logistics of product delivery to the retailer 106. The logistics may include, without limitation, the choice of supplier (e.g., distributor) of the product suited to meeting the prediction of the second ML data model and the time of ordering.

As described herein, virtualized wholesaling benefits small brands and vendors of small brands. However, virtualized wholesaling as a concept may be applicable to a wider variety of vendor, retail, and distributor size, as well as number of products and brands offered, using many of the principles advanced herein. Therefore, any specific embodiment or example described herein should be understood as exemplary and not limiting to their specific contexts.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that, if executed by one or more processors, cause the one or more processors to perform operations comprising:
gathering data from retail sales information comprised of historical retail sales data of products;
compiling a first dataset from the gathered data;
creating a data model for outputting a result as a statistically dependent variable based on input of the first dataset;
applying the data model to the first dataset;
deriving one or more candidate product recommendations from the result of applying the data model to the first dataset;
determining one or more brands that meet the one or more candidate product recommendations and parameters specific to an identifiable retailer; and
providing one or more brand recommendations of the one or more brands to the retailer.

2. The one or more non-transitory computer-readable media of claim 1, wherein the operations further comprise:
adding brand data of the at least one or more brands to the first dataset to form a second dataset;
adding values of one or more independent variables specific to the identifiable retailer to the second dataset; and
applying the data model to the second dataset;
wherein the providing of one or more brand recommendations of the one or more brands to the retailer includes providing the result of applying the data model to the second dataset.

3. The one or more non-transitory computer-readable media of claim 1, wherein the determining of one or more brands that meet the one or more candidate product recommendations and parameters specific to an identifiable retailer includes filtering the one or more candidate product recommendations using brand data of the one or more brands and values of one or more variables specific to the identifiable retailer.

4. The one or more non-transitory computer-readable media of claim 1, wherein:
the operations are performed by a virtualized wholesaler of the one or more brand recommendations; and
the data underlying the first dataset comprises data gathered from the virtualized wholesaler and data gathered from historical retail sales of the identifiable retailer.

5. The one or more non-transitory computer-readable media of claim 4, wherein the data underlying the first dataset comprises data gathered from third-party e-commerce sources.

6. The one or more non-transitory computer-readable media of claim 1, wherein the first dataset comprises historical retail sales data of products sold by the identifiable retailer.

7. The one or more non-transitory computer-readable media of claim 6, wherein the first dataset comprises historical retail sales data of products sold by a plurality of retailers in a market remote from and similar to that of the identifiable retailer.

8. One or more non-transitory computer-readable media storing computer-executable instructions that, if executed by one or more processors, cause the one or more processors to perform operations comprising:
receiving brand information from a vendor regarding a product offered under the brand;
gathering procurement information for the brand;
posting the product for sale;
obtaining the product without regard to presence of an order;
receiving an order for the product from a retailer;
filling the order; and
arranging logistics to consolidate the order with other orders for delivery to the retailer by a demanded time.

9. The one or more non-transitory computer-readable media of claim 8, wherein the operations further comprise:
inputting brand data of the brand as a first statistically independent variable to a data model;
outputting from the data model a predicted order for the product as a first statistically dependent variable for the product based on the first statistically independent variable; and
stocking the product in accordance with the predicted order.

10. The one or more non-transitory computer-readable media of claim 9, wherein the operations further comprise:
inputting retailer data of the retailer as a second statistically independent variable to the data model;
wherein the first statistically dependent variable for the product is based on both the first and second statistically independent variables.

11. The one or more non-transitory computer-readable media of claim 10, wherein the operations further comprise:
inputting to the data model, as a third independent variable, product data obtained from multiple retailers other than the retailer, the product data relating to products not offered under the brand;
wherein the first statistically dependent variable for the product is based on the first, second, and third statistically independent variables; and
wherein the stocking of the product is based on the output of the data model and performed in advance of the predicted order.

12. The one or more non-transitory computer-readable media of claim 11, wherein the procurement information includes the demanded time and information related to obtaining the product from the vendor for stocking, and wherein the operations further comprise:
inputting to the data model, as fourth and fifth independent variables, the demanded time and the information related to obtaining the product from the vendor for stocking, respectively; and
outputting, from the data model, logistical information for the logistics to complete the delivery to the retailer by the demanded time, the logistical information being a second statistically dependent variable for the product delivery based on both the fourth and fifth statistically independent variables.

13. The one or more non-transitory computer-readable media of claim 11, wherein the procurement information includes the demanded time and information related to products to be delivered to the retailer other than the product offered under the brand, and wherein the operations further comprise:
inputting to the data model, as fourth and fifth independent variables, the demanded time and the information related to products to be delivered to the retailer other than the product offered under the brand, respectively; and
outputting, from the data model, logistical information for the logistics to consolidate the order for the product offered under the brand and orders for the products to be delivered other than the product offered under the brand, the logistical information being a second statistically dependent variable for the consolidated product delivery based on both the fourth and fifth statistically independent variables.

14. One or more non-transitory computer-readable media storing instructions that, if executed by a computing device, cause the computing device to perform operations comprising:
compiling from retail sales information a first data set comprised of historical retail sales data of products and values of one or more independent variables specific to an identifiable first retailer, the historical retail sales data including sale dates and sale times for a first product of the multiple products;
developing a trained first machine language (ML) data model from one or more independent variables in the first data set that predicts a change in demand for the first product of the multiple products based on the values of the one or more independent variables in the first data set;
identifying one or more points of interest in the values of the one or more independent variables of the first data set related to changes in demand for the first product;
with the first ML data model, performing a prediction of a change in demand for the first product based on new consumer data and the identified one or more points of interest specific to the first retailer;
compiling from ordering and delivery information a second data set comprised of historical ordering and receiving data for suppliers of the multiple products, historical delivery data of the multiple products to multiple retailers, and values of one or more independent variables specific to the multiple suppliers and the identifiable first retailer, the historical ordering, receiving, and delivery data including expected and actual times of delivery to the multiple retailers;
developing a trained second ML data model from the second data set that predicts an optimized delta between expected delivery time and actual delivery time of the first product to the first retailer without regard to the amount of time between any one order and its corresponding delivery to the first retailer;
with the second ML data model, performing a prediction of a delivery time of the first product to the first retailer based on suppliers of the first product and the identifiable first retailer as independent variables;
controlling the time of ordering the first product in accordance with the prediction of the first ML data model based on the change in demand meeting the point of interest;
controlling arranging logistics of the first product delivery in accordance with the prediction of the second ML data model and the time of ordering.

15. The one or more non-transitory computer-readable media of claim 14, wherein:
the prediction of a change in demand for the first product by the first ML data model is output when the prediction has a first statistical confidence greater than a first threshold; and
the prediction of the delivery time of the first product to the first retailer is output when the prediction has a second statistical confidence greater than a second threshold.

16. The one or more non-transitory computer-readable media of claim 15, wherein the operations further comprise:
feeding back the delta of the delivery of the first product to the first retailer to the second ML data model; and
if the prediction output by the second ML data model based on the fed back delta as an independent variable has less than the second statistical confidence, adjusting the second ML data model and iteratively re-applying the second ML data model to the fed back delta and adjusting the second ML data model until the second statistical confidence exceeds the second threshold.

17. The one or more non-transitory computer-readable media of claim 15, wherein the operations further comprise:
feeding back the delta of the delivery of the first product to the first retailer to the second ML data model; and
if the prediction output by the second ML data model based on the fed back delta as an independent variable has less than the second statistical confidence, and iteratively adjusting the value of the point of interest, re-applying the first ML data model to the point of interest, controlling the time of ordering the first product in accordance with the prediction of the first ML data model, controlling the choice of the same supplier of the first product, and feeding back the new delta to the second ML data model until the second statistical confidence exceeds the second threshold.

18. The one or more non-transitory computer-readable media of claim 14, wherein the operations further comprise:
adding the predicted change in demand to the second data set;
re-training the second ML data model with the change in demand as an independent variable; and
controlling the choice of supplier of the first product in accordance with the prediction of the or the retrained second ML data model and the time of ordering.

19. The one or more non-transitory computer-readable media of claim 14, wherein:
the first data set includes retail sales of data from multiple geographic locations; and
the point of interest is related to a change in demand from the first retailer.

20. The one or more non-transitory computer-readable media of claim 14, wherein:
the first data set includes retail sales of data from multiple geographic locations; and
the point of interest is related to a change in demand from retailers in the multiple geographic locations.
